(19) United States
(12) Patent Application Publication
(10) Pub. No.: US 2009/0109235 A1
(43) Pub. Date: Apr. 30, 2009

(54) DISPLAY DEVICE AND METHOD OF AUTO-ADJUSTING BRIGHTNESS

(75) Inventor: Cing-Shin Lin, Tu-Cheng (TW)

Correspondence Address: PCE INDUSTRY, INC.;ATT. Steven Reiss, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/166,271

(22) Filed: Jul. 1, 2008

(30) Foreign Application Priority Data
Oct. 24, 2007 (CN) 200710202237.8

(51) Int. Cl. G09G 5/10

(52) U.S. Cl. 345/589

(57) ABSTRACT

A display device includes a display panel, an imaging unit, a contrast measuring unit, a detecting unit, a processing unit and an adjusting unit. The imaging unit includes a focus lens, an imaging sensor, and a stepper motor, the focus lens being driven by the stepper motor to a number of predetermined points, and capable of capturing an image at each predetermined point. The contrast measuring unit is for measuring contrast values of the captured images. The detecting unit is for comparing the measured contrast values, and detecting which one of the images has the highest contrast value. The processing unit is for calculating an object distance according to which predetermined point the focus lens was at when it captured the image with the highest contrast value, and generating a control signal. The adjusting unit is for adjusting the brightness of the display according to the control signal generated from the processing unit.

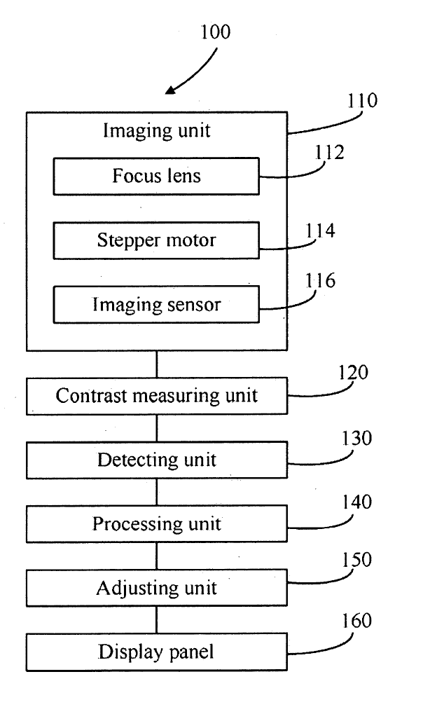

### BACKGROUND

1. Technical Field

The present invention relates to display devices, and particularly to a display device capable of auto-adjusting brightness according to a distance between a user and the display device and a brightness auto-adjusting method thereof.

2. Description of the Related Art

Generally, different viewing distances require a brightness adjustment to a display for comfortable viewing. Accordingly, conventional displays typically have built-in control inputs for manual adjustments of display brightness. These manual adjustments may be inconvenient.

### SUMMARY

A display device includes a display panel, an imaging unit, a contrast measuring unit, a detecting unit, a processing unit and an adjusting unit. The imaging unit includes a focus lens, an imaging sensor, and a stepper motor. The focus lens is driven by the stepper motor to a number of predetermined points and capable of capturing an image at each predetermined point. The contrast measuring unit is for measuring contrast values of the captured images. The detecting unit is for comparing the measured contrast values, and detecting which one of the images has the highest contrast value. The processing unit is for calculating an object distance according to which predetermined point the focus lens was at when it captured the image with the highest contrast value, and generating a control signal. The adjusting unit is for adjusting the brightness of the display according to the control signal generated from the processing unit.

Other advantages and novel features will be drawn from the following detailed description of exemplary embodiments, when considered in conjunction with the attached drawing.

### BRIEF DESCRIPTION OF THE DRAWING

Many aspects of the present display device and method can be better understood with reference to the accompanying drawing. The components in the drawing are not necessarily drawn to scale, the emphasis instead being placed upon clearly illustrating the principles of the present invention.

The accompanying drawing shows functional blocks of a display device capable of auto-adjusting brightness, according to an exemplary embodiment.

### DETAILED DESCRIPTION OF THE EMBODIMENTS

Exemplary embodiments of the present display device and method will now be described in detail below with reference to the drawings.

Referring to the drawing, a display device 100 in accordance with an exemplary embodiment includes an imaging unit 110, a contrast measuring unit 120, a detecting unit 130, a processing unit 140, an adjusting unit 150, and a display panel 160. The imaging unit 110 includes a focus lens 112, an imaging sensor 114, such as a charge coupled device (CCD), and a stepper motor 116. The imaging unit 110 is configured for capturing images of a user in front of the display panel 160. The contrast measuring unit 120 is configured for measuring contrast values of the captured images. The detecting unit 130 is configured for comparing the measured contrast values, and thereby detecting which one of the images has the highest contrast value. The processing unit 140 is configured for calculating an object distance (distance between the user and the display panel 160) according to a position of the focus lens 112 when capturing the image with the highest contrast value, and generating a control signal according to the object distance. The adjusting unit 150 is configured for adjusting the brightness of the display panel 160 based upon the control signal from the processing unit 140.

The imaging unit 110 may be a video camera, and is mounted on a front surface of the display panel 150 so as to capture the images of the user. The focus lens 112 can be driven by the stepper motor 116 to stop at a number of predetermined points/positions. The imaging sensor 114, together with the lens 112, captures an image at each predetermined point.

The contrast measuring unit 120 measures contrast values of the images captured at the predetermined points.

The detecting unit 130 compares the measured contrast values, and thereby detects which one of the images has the highest contrast value.

The processing unit 140 calculates the object distance according to which predetermined point the focus lens 112 was at when it captured the image with the highest contrast value. The processing unit 140 then generates a control signal, for example, a voltage signal, based on the object distance of the focus lens 112.

The adjusting unit 150 is configured for adjusting the brightness of the display panel 150 in accordance with the control signal from the processing unit 130.

When the display device 100 is in operation, the stepper motor 116 moves the focus lens 112 to a number of predetermined points, and an image is captured by the imaging sensor 114 at each predetermined point. The contrast measuring unit 120 measures contrast values of the images, and the detecting unit 130 detects which one of the images has the highest contrast value. The processing unit 140 calculates the object distance, according to which predetermined point the focus lens 112 was at when it captured the image with the highest contrast value, and gives a control signal to the adjusting unit 150 for adjusting the brightness of the display panel 160. This process is repeated until the display device 100 is turned off.

In summary, the display device 100 can determine, utilizing imaging technology, how far away a user is sitting from the display panel 116, and automatically adjust the brightness of the display panel 160 accordingly to prevent eye strain or other injury to the user.

Now we turn to a method for auto-adjusting brightness of the display panel, which is principally illustrated in the preceding exemplary embodiment. The method comprises: moving a focus lens to a number of predetermined points, with an image captured at each predetermined point; measuring contrast values of the captured images; detecting which one of the images has the highest contrast value; calculating an object distance according to which predetermined point the focus lens was at when it captured the image with the highest contrast value; generating a control signal, such as a voltage signal, according to the calculated object distance; adjusting the brightness of the display panel according to the control signal.

It is understandable that the above particular embodiments of the present invention are shown and described by way of illustration only. The principles and features of the present invention may be employed in various embodiments without departing from the scope of the present invention as claimed. The above-described embodiments illustrate the scope of the invention but do not restrict the scope of the invention.

What is claimed is:

1. A display device comprising:
a display panel;
an imaging unit comprising a focus lens, an imaging sensor, and a stepper motor, the focus lens being capable of being driven by the stepper motor to stop at a number of predetermined points and capturing, together with the imaging sensor, an image of an object in front of the display panel at each predetermined point;
a contrast measuring configured for measuring contrast values of the captured images;
a detecting unit configured for comparing the measured contrast values, and detecting which one of the images has the highest contrast value;
a processing unit configured for calculating an object distance according to which predetermined point the focus lens was at when it captured the image with the highest contrast value, and generating a control signal; and
an adjusting unit configured for adjusting the brightness of the display according to the control signal generated from the processing unit.

2. The display device as claimed in claim 1, wherein the imaging unit is installed on a front surface of the display panel.

3. The display device as claimed in claim 1, wherein the control signal is a voltage signal.

4. A method for auto-adjusting brightness of a display panel, the method comprising:
moving a focus lens to a number of predetermined points, and capturing an image of an object in front of the display panel at each predetermined point;
measuring contrast values of the captured images;
detecting which one of the images has the highest contrast value;
calculating an object distance according to which predetermined point the focus lens was at when it captured the image with the highest contrast value;
generating a control signal according to the calculated object distance; and
adjusting the brightness of the display panel according to the voltage signal.

5. The method as claimed in claim 4, wherein the control signal is a voltage signal.
